(19) United States
(12) Patent Application Publication
(10) Pub. No.: US 2014/0219741 A1
(43) Pub. Date: Aug. 7, 2014

(54) RECEPTACLE ARRANGEMENT FOR ELONGATED FASTENER AND NUT

(71) Applicant: CATERPILLAR INC., Peoria, IL (US)

(72) Inventors: Francis E. Fortner, Woodway, TX (US); Rakesh D. Jagdale, Waco, TX (US); Dimitar Dostinov, Fort Worth, TX (US); Stephen Amborski, China Spring, TX (US)

(73) Assignee: Caterpillar Inc., Peoria, L (unknown)

(21) Appl. No.: 13/760,507

(22) Filed: Feb. 6, 2013

(51) Int. Cl. F16B 41/00

(52) U.S. Cl. CPC F16B 41/002
USPC 411/172

(57) ABSTRACT

A receptacle arrangement for an elongated fastener and a nut is disclosed. The receptacle arrangement includes an assembly of two or more stacked blocks. The assembly defines an elongated receptacle extending through a first block up to a mid portion of a second block. The elongated receptacle is configured to receive the elongated fastener. A receptacle obliquely extends across the elongated receptacle and mutually adjoining surfaces of the second block. The receptacle is configured to slidably receive the nut such that the elongated fastener engages into the nut.

### TECHNICAL FIELD

The present disclosure relates to a receptacle arrangement, and more particularly to a receptacle arrangement for an elongated fastener and a nut.

### BACKGROUND

Fastening elements in typical vibrating or reciprocating machines may be oriented such that the fastening elements are constrained in axial tension by applying preload forces. These fastening elements, loaded in tension, may also experience bending loads leading to premature failure of the fastening elements.

United States Publication No. 2010/0139939 relates to a hydraulic breaker assembly including a head cap, a cylinder, and a front head, which are mounted in a casing, wherein corresponding faces of the front head and the cylinder are connected by connecting pins, wherein the cylinder and the head cap located above the cylinder are fixed together by fastening bolts, and wherein the front head, the cylinder, and the head cap are supported on an inner side of the casing by variable dampers, which are brought into close contact with the front head, the cylinder, and the head cap. The movement in the casing is thus prevented so that the head cap, the cylinder, and the front head are strongly coupled together. The length of the fastening bolt is reduced to minimize the impact-generating section so that the bolt is protected from distortion stress occurring upon striking of the rod, thereby increasing durability.

### SUMMARY OF THE DISCLOSURE

In one aspect of the present disclosure, a receptacle arrangement for an elongated fastener and a nut is provided. The receptacle arrangement includes an assembly of two or more stacked blocks. The assembly defines an elongated receptacle extending through a first block up to a mid portion of a second block. The elongated receptacle is configured to receive the elongated fastener. The assembly further defines a receptacle obliquely extending across the elongated receptacle and mutually adjoining surfaces of the second block. The receptacle is configured to slidably receive the nut such that the elongated fastener engages into the nut.

In another aspect of the present disclosure, a hydraulic breaker assembly is provided. The hydraulic breaker assembly includes a back head and a front head. The back head and the front head define an elongated receptacle extending from the back head to a mid portion of the front head. The elongated receptacle is configured to receive an elongated fastener. The back head and the front head further define a receptacle disposed obliquely across the elongated receptacle and mutually adjoining surfaces of the front head. The receptacle is configured to slidably receive a nut such that the elongated fastener engages into the nut.

In a yet another aspect, a machine is provided. The machine includes a prime mover and a hydraulic breaker assembly coupled to the prime mover. The hydraulic breaker assembly includes a back head and a front head. The back head and the front head define an elongated receptacle extending from the back head to a mid portion of the front head. The elongated receptacle is configured to receive an elongated fastener. The back head and the front head further define a receptacle disposed obliquely across the elongated receptacle and mutually adjoining surfaces of the front head. The receptacle is configured to slidably receive a nut such that the elongated fastener engages into the nut.

Other features and aspects of this disclosure will be apparent from the following description and the accompanying drawings.

### BRIEF DESCRIPTION OF THE DRAWINGS

FIG. 1 illustrates an exemplary machine including a hydraulic breaker assembly, according to an embodiment of the present disclosure;

FIG. 2 illustrates an exploded view of the hydraulic breaker assembly employing an arrangement of an elongated receptacle and a cylindrical receptacle;

FIG. 3 illustrates a receptacle arrangement according to another exemplary embodiment of this disclosure; and

FIG. 4 illustrates a perspective break-away view of the receptacle arrangement of FIG. 3.

### DETAILED DESCRIPTION

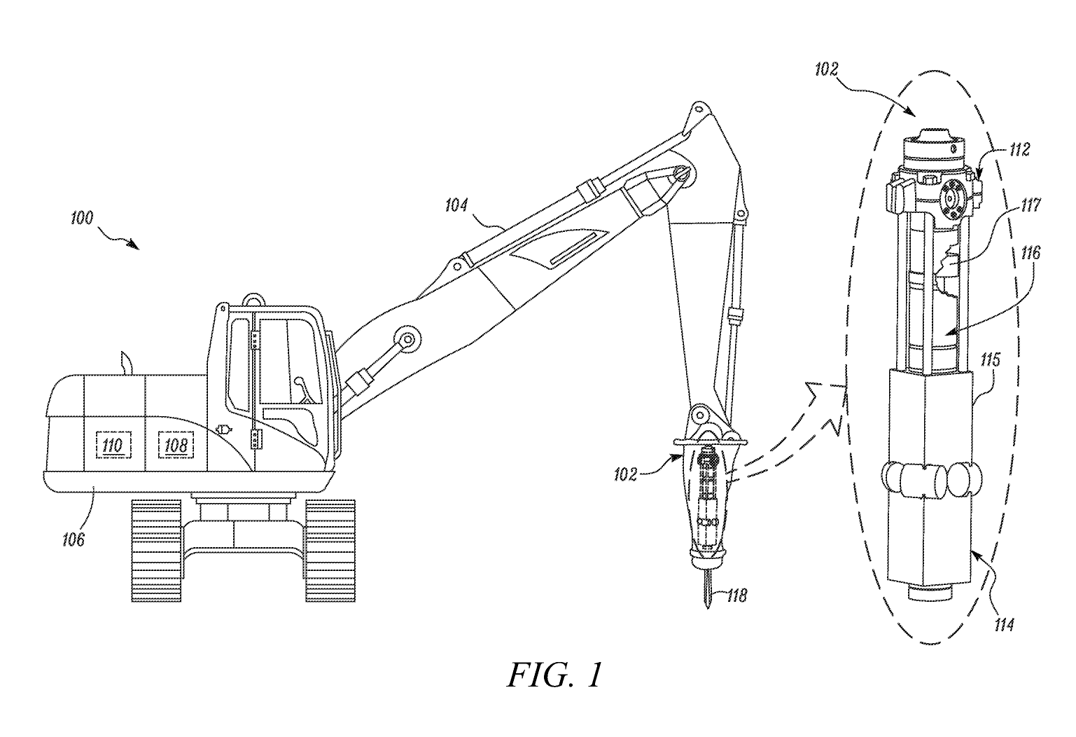

The present disclosure relates to a receptacle arrangement for an elongated fastener and a cylindrical nut. FIG. 1 illustrates an exemplary machine 100, according to an embodiment of the present disclosure. In an embodiment as shown in FIG. 1, the machine 100 may be a tracked or wheeled type of industrial vehicle, such as an excavator. The machine 100 includes a hydraulic breaker assembly 102 configured to break rocks and drill ground surfaces. In other embodiments, the machine 100 may be a soil compactor or a skid steer loader configured work on a ground surface.

As shown in FIG. 1, the machine 100 includes a frame 106. The hydraulic breaker assembly 102 is pivotally connected to the frame 106 via one or more linkages 104. The machine 100 further includes a prime mover 108 configured to drive a pump 110. The pump 110 is configured to supply pressurized fluid and power the hydraulic breaker assembly 102. In one embodiment, the hydraulic breaker assembly 102 includes a back head 112, a front head 114, and a cylinder 116 disposed between the back head 112 and the front head 114.

The front head 114 is releasably connected to the back head 112. The back head 112 may include a valve assembly configured to allow pressurized fluid into the cylinder 116 such that a piston 117 disposed in the cylinder 116 drives a striker rod 118 at the front head 114.

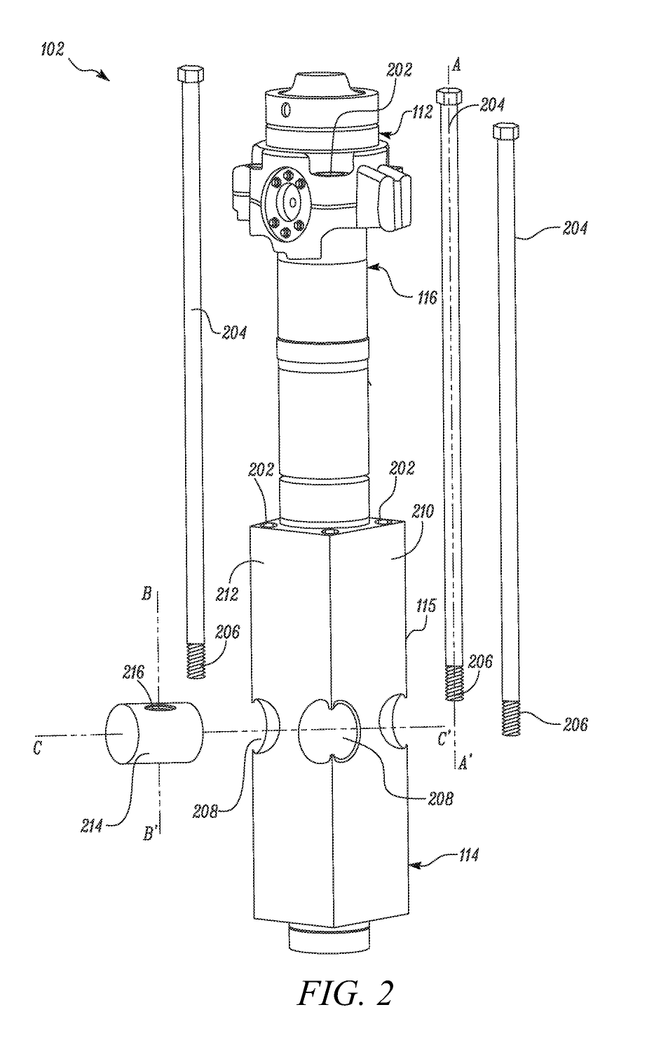

FIG. 2 illustrates an exploded view of the hydraulic breaker assembly 102 of the present disclosure. The front head 114 and the back head 112 together define an elongated receptacle 202 extending from the back head 112 to a mid portion 115 of the front head 114. The elongated receptacle 202 is configured to receive an elongated fastener 204 such as a tie rod or an elongated bolt. In one embodiment, the elongated fastener 204 includes a threaded end 206.

Further, the front head 114 defines a cylindrical receptacle 208 obliquely extending across the elongated receptacle 202 and across mutually adjoining outer surfaces 210, 212 of the front head 114. The cylindrical receptacle 208 is configured to slidably receive a cylindrical nut 214 including an internal threaded receptacle 216. An axis C-C′ of the cylindrical nut 214 is co-axial to the cylindrical receptacle 208 disposed in the front head 114. Further, a longitudinal axis A-A′ of the elongated fastener 204 is co-axial to a longitudinal axis B-B′ of the internal threaded receptacle 216 of the cylindrical nut 214. Therefore, upon positioning the elongated fastener 204 and the cylindrical nut 214 within respective receptacles 202, 208, the threaded end 206 of the elongated fastener 204 engages with the internal threaded receptacle 216 of the cylindrical nut 214 and hence, fastens the back head 112 to the front head 114.

Although an arrangement of the elongated receptacle 202 and the cylindrical receptacle 208 is disclosed in conjunction with the hydraulic breaker assembly 102, it is to be noted that the hydraulic breaker assembly 102 is merely exemplary in nature and hence, non-limiting of this disclosure. The arrangement of the elongated receptacle 202 and the cylindrical receptacle 208 may be employed to fasten any given pair of structures that are subjected to tensile and bending loads. One example of such structures is a typical engine head and an engine crank case of an engine that are fastened using the arrangement of receptacles 202, 208 and the fastening elements 204, 214 disclosed herein. As known to one having ordinary skill in the art, the engine head typically experiences combustion forces that may force the engine head away from the crank case. In such cases, the receptacles 202, 208 and the fastening elements 204, 214 may reduce bending of the elongated fasteners.

For purposes of understanding, the arrangement of the elongated receptacle 202 and the cylindrical receptacle 208 disclosed herein, may be collectively referred to as a receptacle arrangement 300. One such exemplary embodiment is explained below without deviating from the scope of this disclosure.

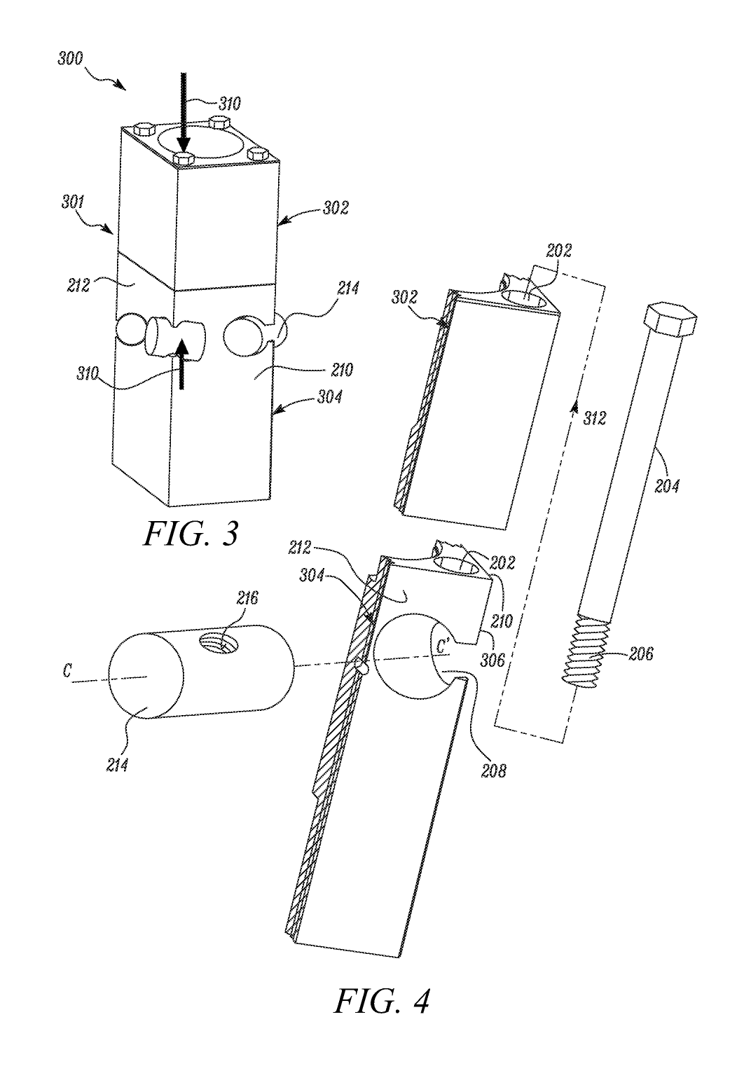

As shown in FIGS. 3-4, the receptacle arrangement 300 may include an assembly 301 of two or more blocks 302, 304 stacked one above the other. The second block 304 includes the mutually adjoining outer surfaces 210, 212. Further, as shown in FIG. 4, the assembly 301 defines the elongated receptacle 202 disposed in the side wall 318 of the first block 302. The elongated receptacle 202 extends to a mid portion 306 of the second block 304. The elongated receptacle 202 is configured to receive the elongated fastener 204 as shown by arrow 312. The elongated fastener 204 may be a tie rod having the threaded end 206.

Further, the receptacle arrangement 300 includes the cylindrical receptacle 208 disposed in the second block 304. The cylindrical receptacle 208 extends obliquely through the elongated receptacle 202 and the mutually adjoining outer surfaces 210, 212 of the second block 304. The cylindrical receptacle 208 is configured to slidably receive the cylindrical nut 214, such that the elongated fastener 204 engages with the cylindrical nut 214. The cylindrical nut 214 and the cylindrical receptacle 208 are co-axial to each other. The cylindrical nut 214 includes the internal threaded receptacle 216. The internal threaded receptacle 216 of the cylindrical nut 214 is co-axial to the elongated fastener 204. The threaded end 206 of the elongated fastener 204 is configured to engage in the internal threaded receptacle 216 of the cylindrical nut 214 to fasten the two blocks 302, 304.

It is to be noted that for the receptacle arrangement 300 of the present disclosure, under the pre-load tensile forces which act on the elongated fastener 204 and the cylindrical nut 214, the cylindrical nut 214 is able to slip within the cylindrical receptacle 208 to relieve bending of the elongated fastener 204 caused by the uneven deformation cylindrical receptacle 208.

### INDUSTRIAL APPLICABILITY

Fastening elements in typical vibrating or reciprocating machines may be oriented such that fastening system is constrained in axial tension by applying preload forces. These fastening elements may also experience bending forces leading to premature failure of the fastening elements.

In the receptacle arrangement 300 of the present disclosure, the receptacles 202, 208 are oriented such that during operation of the machine 100, a possibility of bending the elongated fastener 204 is mitigated due to the relative slipping of the cylindrical nut 214 in the cylindrical receptacle 208.

Conventionally, due to tensile loads, elongated fasteners of hydraulic breaker assemblies would tend to pull cylindrical nuts in an upward direction thereby forcing abutting surfaces of the associated nut pocket to deform unevenly. However, orientation of the cylindrical receptacle 208 and the elongated receptacle 202, according to the embodiments of the present disclosure, enables the front head 114 to slip about the cylindrical nut 214 and vice-versa. Therefore, the cylindrical nut 214 remains compliant within the cylindrical receptacle 208 that prevents bending of the elongated fastener 204.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A receptacle arrangement for an elongated fastener and a nut, the receptacle arrangement comprising:
an assembly of two or more stacked blocks, the assembly defining:
an elongated receptacle extending from a first block to a mid portion of a second block, the elongated receptacle configured to receive the elongated fastener; and
a receptacle obliquely extending across the elongated receptacle and mutually adjoining surfaces of the second block, the receptacle configured to slidably receive the nut such that the elongated fastener engages into the nut.

2. The receptacle arrangement of claim 1, wherein the nut and the receptacle are cylindrical in shape.

3. The receptacle arrangement of claim 1, wherein the nut includes an internal threaded receptacle configured to engage with a threaded end of the elongated fastener.

4. The receptacle arrangement of claim 3, wherein the internal threaded receptacle and the elongated fastener are co-axial.

5. The receptacle arrangement of claim 1, wherein the nut and the receptacle are co-axial.

6. The receptacle arrangement of claim 1, wherein the elongated fastener is one of a tie rod and an elongated bolt.

7. A hydraulic breaker assembly including:
a back head and a front head defining:
an elongated receptacle extending from the back head to a mid portion of the front head, the elongated receptacle configured to receive an elongated fastener; and
a receptacle obliquely extending across the elongated receptacle and mutually adjoining surfaces of the front head, the receptacle configured to slidably receive a nut such that the elongated fastener engages into the nut.

8. The hydraulic breaker assembly of claim 7, wherein the nut and the receptacle are cylindrical in shape.

9. The hydraulic breaker assembly of claim 7 further including a cylinder disposed between the back head and the front head.

10. The hydraulic breaker assembly of claim 7, wherein the nut includes an internal threaded receptacle configured to engage with a threaded end of the elongated fastener.

11. The hydraulic breaker assembly of claim 10, wherein the internal threaded receptacle and the elongated fastener are co-axial.

12. The hydraulic breaker assembly of claim 7, wherein the nut and the receptacle are co-axial.

13. The hydraulic breaker assembly of claim 7, wherein the elongated fastener is one of a tie rod and an elongated bolt.

14. A machine comprising:
a prime mover; and
a hydraulic breaker assembly coupled to the prime mover, the hydraulic breaker assembly comprising:
a back head and a front head defining:
an elongated receptacle extending from the back head to a mid portion of the front head, the elongated receptacle configured to receive an elongated fastener; and
a receptacle obliquely extending across the elongated receptacle and mutually adjoining surfaces of the front head, the receptacle configured to slidably receive a nut such that the elongated fastener engages into the nut.

15. The machine of claim 14, wherein the machine is at least one of an excavator and a skid steer loader.

16. The machine of claim 14, wherein the hydraulic breaker assembly further comprising a cylinder disposed between the back head and the front head.

17. The machine of claim 14, wherein the nut and the receptacle are cylindrical in shape.

18. The machine of claim 14, wherein the nut includes an internal threaded receptacle configured to engage with a threaded end of the elongated fastener.

19. The machine of claim 18, wherein the internal threaded receptacle and the elongated fastener are co-axial.

20. The machine of claim 14, wherein the nut and the receptacle are co-axial.
